(19) United States
(12) Patent Application Publication
(10) Pub. No.: US 2021/0174006 A1
(43) Pub. Date: Jun. 10, 2021

(54) SYSTEM AND METHOD FOR FACILITATING COMPLEX DOCUMENT DRAFTING AND MANAGEMENT

(71) Applicant: TEAMBENTO LIMITED, Petersfield (GB)

(72) Inventor: Andrew Stokes, Petersfield (GB)

(21) Appl. No.: 17/117,523

(22) Filed: Dec. 10, 2020

(30) Foreign Application Priority Data
Dec. 10, 2019 (GB) 1918084.3

(51) Int. Cl. G06F 40/166; G06F 3/0486; G06F 40/197

(52) U.S. Cl. CPC G06F 40/166; G06F 40/197; G06F 3/0486

(57) ABSTRACT

A system and method for facilitating complex document drafting and management is described. A data repository stores a plurality of document elements, each document element including at least a part of a clause for use in a complex document and each individual clause including provisions and terms relating to conditions affecting one or more parties, one or more of the document elements comprising a variable document element which includes variables to be substituted with content when an instance of the document element is used to create a complex document. A database encodes data objects, each data object relating to a document element in the data repository, the database defining a framework, the framework comprising a hierarchy of the data objects. A user interface is used to retrieve variable values and the complex document is compiled by retrieving the document elements from the data repository, populating the variables with the user inputs and combining the document elements according to the hierarchy. The document elements are maintained independently of the complex documents, the document elements being independently updatable and usable across multiple complex documents.

### CROSS-REFERENCE TO RELATED APPLICATION

This application claims priority to GB Patent Application No. 1918084.3 filed Dec. 10, 2019, the contents of which are incorporated by reference in its entirety as if set forth herein.

### FIELD OF THE INVENTION

The present invention relates generally to contract, technical requirements/specification documentation and know how document management systems that automate the generation and management of complex documents that are executed to form contractual agreements or which can serve as complex technical requirements/specification documentation, know how documentation or advisory memoranda.

### BACKGROUND TO THE INVENTION

There are many types of complex documents. One example is a written contract. Written contracts are commonly used to document agreements that have been negotiated between two or more business or other persons or entities. These contracts are typically in the form of written documents that include great deal of detail in an attempt to avoid later disagreements between the parties. These contracts are critical as they define the obligations between the parties to the contract, such as the terms of payment, warranties and indemnities, product or service to be delivered, and many other conditions relevant to the parties to the contract. Contracts tend to be prepared individually for each agreement.

Other types of complex documents include technical specifications and standards, schedules of contracts or policies, invitations to tender and tender documentation, know how documentation and the like. Many of these will contain technical and/or legal requirements and/or specifications.

These requirements or specifications usually constitute and record the fine detail of a specific person's obligations. Producing and maintaining requirements and specification documentation often involves substantial effort and time.

Know how documentation or advisory memoranda are commonly used in the legal field and in many other areas of expertise to record, explain and explore those areas of expertise. The legal or other technical ramifications of the subject matters in question often form the basis of advisory memoranda which aid decision making. It is critical that know how documentation be kept up to date, if its authoritative value is to be maintained.

While there is no mandatory form for such complex documents, it is desirable for there to be structure in order to improve readability and understandability. Preferably, each of these types of complex documents is made of a number of blocks of content (content blocks) of any arbitrary type. Preferably, they are assembled in a structured manner and internally consistent. Depending on the type of complex document the make-up of a content block may vary. In a contract they might contain a contractual clause or a defined term. In a specification it might describe a standard to be complied with. In a know how document it might describe a point of law.

Irrespective of the type of complex document in question and the content block that it uses, complex documentation requires considerable expertise, clarity of expression and attention to detail to draft, check for completeness and proof-read.

Complex document drafting involves substantially more thought and effort than merely sending out a template form. Individual terms and clauses tend to be highly particularized and often have legal, commercial or technical ramifications or include terms of art. Those terms and clauses are then assembled into structured documents.

Drafting complex documents such as contracts is a highly skilled job, especially where the documents have a significant legal, commercial or technical impact.

A capable draftsperson will take into account numerous factors in crafting a document, including, for instance, the nature and scope of the subject matter, the characteristics and relative positions of the parties concerned, customary practices in the field, required language, language used in prior dealings, enforceability/applicability of terms and conditions or other content, and jurisdictional and applicable lawconsiderations, to name a few. The ability to identify which of these factors is pertinent to a given situation depends on the knowledge and experience of the draftsperson.

Another important part of the drafting process is ensuring that the document is internally consistent and complete, both from a semantic perspective (no missing or conflicting obligations, concepts, citations or defined terms, for example) and in terms of proofing (no typographical errors or erroneous cross references, for example). This aspect of draftsmanship demands considerable attention to detail and the ability to detect contradictions and omissions in a body of text that sometimes can run to eighty pages or more.

The range of skills, knowledge and experience required of a draftsperson makes drafting a cognitively demanding process. Document drafting is not easily taught and can be a time-consuming process, particularly for those who are inexperienced or untrained. It is also fraught with risk, not only of including something inappropriate but also missing a key issue out.

These issues are exacerbated when multiple parties take part in the process, either in collaborative drafting or when complex documents are being negotiated between parties.

In a legal or other technical setting, teams of attorneys, in-house counsel or other subject matter specialists often cooperatively service the document drafting needs of a single client for cost and time efficiency. Some clients require standardized language and consistency becomes a concern, individual work products can reflect variations in style, skill, and experience level. A sense of consistency, and possibly legal or technical effect, can be lost due to these variations. Moreover, maintaining control over the countless variations in work product poses a major challenge to the subject matter specialist responsible to the client. There is also a degree of competition that can be observed when two opposing parties are negotiating a complex document—each will typically want their format/clauses/definitions. Each negotiated change can impact the overall document—both in terms of intended effect and its internal consistency.

In basic existing systems, templates combined with word processing programs provide limited automated document drafting capabilities.

Templates enable users to create a table of shareable skeletal boilerplates. Each template can be populated with clauses and specific content based on user selections and pre-defined merge codes, thereby allowing a moderate level of customizability.

### STATEMENT OF INVENTION

This statement of invention uses the particular case of contractual drafting. Nonetheless the statement set out extends to the all of the forms of complex documentation referred to in this document and any arbitrary constituent content block type.

According to an aspect of the present invention, there is provided a system for facilitating complex document drafting and management, comprising: a data repository storing a plurality of document elements, each document element including at least a part of a clause for use in a complex document and each individual clause including provisions and terms relating to conditions affecting one or more parties, one or more of the document elements comprising a variable document element which includes variables to be substituted with content when an instance of the document element is used to create a complex document, one or more of the document elements comprising a definition document element giving semantic definition to expressions used within other document elements;

a database encoding data objects, each data object relating to a document element in the data repository, the database defining a framework, the framework comprising a hierarchy of the data objects whereby document elements of subordinate data objects in the hierarchy override or populate document elements of superior data objects in the hierarchy;

a processor configured to execute computer program code to parse the framework and retrieve the logical collection and hierarchy of data objects of the framework from the data repository to identify the variables in the document elements;

a user interface configured to generate a human readable questionnaire on the variables, to obtain user inputs on the variables and store the user inputs in the database;

the processor being further configured to execute computer program code to compile the complex document by retrieving the document elements from the data repository, populating the variables with the user inputs and combining the document elements according to the hierarchy, wherein the document elements are maintained independently of the complex documents, the document elements being independently updatable and usable across multiple complex documents.

The data repository may further store a collection element, the collection element linking to a plurality of the document elements and the collection element being usable in place of a document element in the framework, the processor being further configured to execute computer program code to compile the complex document from a framework by retrieving the document elements corresponding to each collection element in the framework, populating the variables with the user inputs and combining the document elements according to the hierarchy, wherein the collection elements are maintained independently of the complex documents, the collection elements being independently updatable and usable across multiple complex documents.

The system may further comprise a plurality of collection elements wherein at least two of the collection elements link to a same one of the document elements, whereby the provisions and terms from the document element are used in the at least two collection elements and an update to the document element causes an update to all instances of the document element in a complex document when the complex document is compiled.

The collection element in the data repository preferably includes a logical operator such as AND OR XOR etc that dictates how to combine collection elements.

The database may further comprise a record for each compiled complex document, its framework and document element and collection elements used.

The system may further comprise a graphical user interface configured to display a graphical representation of the framework, the graphical user interface being configured to receive user inputs on drag and drop operations to manipulate the framework and is responsive to update the framework in the database in accordance with the user inputs.

The system may further comprise a graphical user interface configured to display a graphical representation of the document elements and collection elements in the data repository, the graphical user interface being configured to receive user inputs on drag and drop operations to add, remove or move document elements or collection elements in the framework and is responsive to update the framework in the database in accordance with the user inputs.

Upon a change corresponding to a document element, the system may be configured to create a copy of the document element, update the hierarchy to refer to the copy and apply the change to the copy.

The graphical user interface may be configured to receive user inputs on positioning of a clause in the complex document, the processor being configured to execute computer program code to identify, from the changes to the complex document, one or more changes to the hierarchy to reflect changes to positioning of the clause and to update the hierarchy in dependence on the changes.

Each document element preferably comprises a json object.

The processor may be configured to execute each json object according to the hierarchy when compiling the complex document.

For the purposes of the present application, examples are set out below for legal contract type complex documents. Nonetheless, it will be appreciated that embodiments could he used for other complex document types such as those set out above.

Some existing systems allow traditional agreements to be marked up to specify the application of clauses, conditional fallback provisions and specific content based on user selections and variables, thereby allowing more customizability,

However, the creation of marked up automated contract templates and their questionnaires is itself a skilled and fastidious task, often requiring a software developer and a lawyer to work together to automate each individual template.

Creating and maintaining templates that reuse the same content generally has a high risk of inconsistency. Even where systems provide reusability, templates generally still carry document content that is local to themselves and so are harder to maintain.

Maintenance of reused content is repetitious and error prone. The same content needs to be updated every time that it is used.

Furthermore, existing systems do not alleviate the cognitive charge involved in ensuring the internal consistency and completeness of an automated contract template—for example the draftsperson will have to identify and include all defined terms used in a template, as in manual drafting. Finally, once the template is populated and turned into a word processing or other format document it is often changed further, internally or by third parties. In so doing the document drifts from the original and the contextual data present at its creation is lost.

Therefore, there is a need for an fresh approach to the automated drafting of complex documents, particularly contracts, capable of:

Facilitating the process of creating automated templates and generally reducing the cognitive burden on the draftsperson and general user throughout the template and contract creation process;

Automating certain internal consistency and completeness tasks;

Keeping track of complex documents once they are downstream of the creation process, so that theft data is not lost and (for example) negotiated changes and updates can be applied to them after their creation;

Enabling true reusability and portability of intra-document content, reliably imparting expert knowledge, consistency and efficiency to the drafting process independent of the user;

Ensuring that maintaining reused content is not repetitious, saving time and cost and reducing errors,

Enabling industry leader and community driven collaborative creation of automated document frameworks.

Embodiments may include a database recording a series of idempotent change sets tracking the creation and updating of the data repositories, logical collections and complex document instances.

The processor may be configured to execute computer program code to receive change sets originating from the user interface or programmatically and accordingly implement the requested creation, update and deletion of data repositories, logical collections and complex documents.

The processor may be configured to execute computer program code to parse a selected logical collection and hierarchy of the data objects to generate an instruction change set for the creation of a general case of a complex document.

Preferably, embodiments include a user interface configured to use the instruction set to generate a human readable questionnaire allowing the general case of a complex document to be particularised by choosing clause options, applying conditional clause logic and populating variables, storing user inputs in the database as an instruction change set;

In a negotiation or collaborative drafting context the user interface may be configured to allow users to make, accept or reject counter-proposals for the wording of a given clause or definition in a complex document instance. The counter proposals, their status and the parties' comments may be generated visually and captured in JSON objects, the revised instruction change set being stored in a database.

The processor may be configured to execute computer program code to compile the complex document by parsing the instruction changes set (negotiated or otherwise) and hierarchy of data objects and to:

identify and add the applicable clauses to the partially instantiated complex document;

achieve and verify document internal completeness, for example by identifying and adding the defined terms used in the clauses and add a completed table of definitions to the partially instantiated complex document, cross referenced as necessary. Any missing definitions can be identified by the same process;

identify and add cross references to technical sources such as case law; identify the variables in the partially instantiated complex document and populate them with the user inputs from the instruction change set.

The processor may populate the variables with values calculated by the processor or provided by an arbitrary remote API or other source of data.

The processor may be configured to detect changes in a framework's data repository and dependant logical collections and to update each complex document instance affected automatically or in accordance with user instructions.

The processor may be configured to allow the downloading of the contents of a data repository and its dependant logical collections in human readable documentary form at any time.

The processor may be configured to allow the uploading of a data repository and its dependant logical collections in human readable documentary form, parse the documents and use them to create a fully functioning document automation framework.

The processor may be configured to allow the extraction of the change sets pertaining to a framework's data repositories and logical collections and their uploading to version controlled private or public archives for access by third parties (holding any necessary authorisations the case may be).

The processor may be configured to allow the downloading and processing of a particular version of framework's archived change sets, allowing the implementation of a fully functioning document automation framework from the archive.

The processor may be configured to allow a user to define and version control scripts for the creation or updating of a custom framework citing the application of an arbitrary sequence of change sets sourced from archives and/or the user's frameworks on the platform, allowing the implementation of a fully functioning customised document automation framework.

In preferred embodiments, the document elements each have a machine readable form (preferably having a JSON encoded form stored in a file or database) and a corresponding word-processable file (such as an MS Word (®) document). Document elements exist in this dual form and should one of the two forms be updated, the system is configured to update the other to reflect it. In this way, the document elements can be edited in a word processor or as code.

Preferably, actions on document elements are recorded as a sequence or recipe of commit actions. This recording can be used to recreate an equivalent framework that can be used, edited or extended as desired. Additionally, updates can be pushed to holders of the framework so that it reflects frameworks held elsewhere. In this manner, remote control of frameworks can be provided to organisations having distributed systems or facilities. Additionally, frameworks can be maintained as a service—they can be licensed or otherwise purchased or shared and as and when the originator (or someone else) updates it, these updates can be shared as the recorded commit actions. Not only does this reduce communication overhead, it also minimises what is being communicated so that sensitive information does not need to leave the respective repositories.

Embodiments are preferably based on a document abstraction model formed from a three level Library/Template/Document automation model represented by word processable (e.g. .docx) documents and JSON mirror objects. In a UI preferably only the JSON objects are manipulated, allowing for a visual interface.

Embodiments enable:

Creation of a highly interactive UI including instruction workflow modals, clause, variable, definition and metadata edit modals and a visual template editor. Highly interactive chatbot and other UIs can also be used with embodiments.

Creation of JSON schemas representing the content, clause directives and metadata in library and template and documents. Each document type has its own schema.

Creation of JSON schema representing a dual use instruction set for the display of contract questionnaires, the capture of responses to the questionnaire and the generation of a contract from the completed questionnaire.

Creation of JSON schema representing a commit (creation or alteration) of a library or template document.

Creation of a system of inline macro markups, tables and footnotes in library, .docx documents to represent its clause, variable and definition content and various types of metadata.

Creation of ‘thin’ templates, containing no clause text but a clause directive markup and metadata macros and footnotes to represent the clause logic and metadata in a template document .docx document.

Binding arbitrary functionality to arbitrary content blocks, such as clause-code binding or API binding to recalculate variable values.

Creation of systems that can read a .docx document and extract content and metadata, converting it to a JSON object of the relevant JSON schema. Creation of systems that can take one or more JSON commit objects and create or alter an underlying .docx.

Advantageously, the document abstraction model can be as abstract or as finely grained as needed. Clauses, variables, definitions, clause logic, metadata, numbering and style are preferably all abstracted. Advantageously, elements in the document abstraction model are modular. Simpler or indeed atomic document elements can be combined to produce other more complex document elements, enabling efficient and consistent reuse of complex document elements.

From a content management perspective each library, template and contract can be represented by a post in a content management system's database or by a vertex in a graph database. Relationships between libraries, templates and contracts may be recorded as taxonomies, or in relationship tables. Alternatively, they may be edges in a graph database Each version of the contract/library/template is preferably represented by a mirror word processable (.docx) document that is preferably saved in a local or shared file system and its JSON mirror (preferably saved as metadata to the post or as a connected vertex in a graph database).

The .docx document is easily shared and can be used to instantiate libraries and templates for other users or on other instances of the system.

One of the benefits of the dual abstraction model is that libraries or templates can be built up from scratch by layers of JSON object ‘commits’ and the resulting .docx derived automatically. This can be used to clone a library or template, but can also be used as the data structures underlying a drag and drop user interface allowing users to specify the lineage of a child library using all (full inheritance) or part (traits) of a series of parent libraries. Updates of the underlying libraries can be flowed into the child library by rerunning the build of the layers of the library. Template inheritance can work the same way.

The dual abstraction model used in embodiments of the present invention (document and json or similar forms) has a number of advantages:

1. Robustness and Disaster Recovery.

The system allows several pathways between docx and json models. This structured duality provides several recovery options if a docx document or a json object is lost.

In one embodiment, the system treats the document of a library or template as a reference source, allowing the json meta data associated with a library or template to be derived at any time. If that meta data were to be lost or corrupted, regenerating it is trivial, given the word document.

Similarly, if a copy of the current meta data for a library or template exists, a full cloning commit object can be derived from the meta data (either programmatically or manually by using the user interface to just display the meta data and then clone the library or template). The commit object can then be used to re-derive the document.

If the chain of commit objects leading to a library or template is available (perhaps archived in a shared online repository) re-deriving the document is also trivial.

Once library and template and their metadata are available, instructions can be regenerated. If the old instructions exist, user answers can be reconstituted, approximating the state that a user might have left an agreement in.

2. Human Readability

The document versions of libraries and templates are human readable, allowing them to be exported, reviewed and edited on paper or in a word processor.

In libraries the text of clauses and definitions and instances of definition and variable use are readable on the face of the document. Clauses are delimited by macros such as ${L@CLAUSENAME}, variables are macros ${V_VARIABLENAME}. The meta data associated with a given clause or variable is found in a footnote to the initial clause macro or the first instance of a variable macro or a variable admin macro if the variable is an orphan —unused by a clause.

The clause directives in a template are simple to decipher—this directive for example gives the choice between two clauses, the first being the default one.

${L@CLAUSE4; DEFAULT>PARTYCLAUSEYOU; ELSE>PARTYCLAUSEA}

3. Playing to the strengths of XML and JSON Having libraries and templates in two different formats allows different processing tasks to be carried out more efficiently by selecting the appropriate format for a given task.

For example, XML is better than JSON for encoding layout, styling, number formatting and so forth on a very granular level (parts of a paragraph can be given specific run level formatting, specific numbering styles can be defined, the sequence of paragraphs or other body level objects like tables is immediately apparent).

By contrast, JSON is better than XML for encoding abstract relationships between different objects in a simple way. JSON can be embedded in other JSON objects, can be stored in a database and even can be indexed, searched and queried if stored in a NOSQL database such as MongoDB or in other ways. JSON is widely consumable by a range of client or server programming languages and is well suited to rendering objects in graphical user interfaces. Having this choice between two formats provides implementation flexibility.

4. Mitigating Scaling Issues And Satisfying Evolving Product Features/Business Needs.

Scaling applications (in terms of numbers of users, datasets, performance, geographical location etc) presents several non-trivial challenges. A working prototype may not be capable of scaling because of the way in which it is implemented.

In one embodiment, the system is configured to be scalable and to perform at scale (in the terms listed above) by being split into simpler parts (microservices) and to scale the number of instances of each microservice horizontally. This delivers the ability to scale by providing a number of identical instances of dedicated microservices each performing a restricted range of tasks. This is a strategy that works well for tasks that do not depend on a database, or which can in some way share a separate virtual data store or virtual file system. Preferably, the microservices are stateless.

Preferably, embodiments use a shared scalable file system designed to serve the instances of the horizontally scaled microservices. It may use, for example, AWS EFS (a managed cloud service providing a network file system solution) or CEPH or GlusterFS (two popular open-source solutions). The shared system allows each instance to access the files they need to, for example, generate a document. Object storage services such as AWS S3 can be used to back up shared file systems.

By contrast, creating a shared and scalable data store is much more complex. Scaling a relational database horizontally involves managing read/write requests, splitting (sharding) the tables in the database onto separate machines and often replicating reference/master tables and/or caching tables to provide I/O bandwidth and performance. Maintaining appropriate ‘ACID’ (atomicity, consistency, isolation, durability) properties for database read and write operations over a horizontally scaled datastore is non-trivial and requires skilled and costly database configuration, administration and operations skills.

See http://en.wikipedia.org/wiki/ACID

Even if a horizontally scaled relational database is implemented successfully, performing complex relational database join operations between multiple tables with large datasets and at high volume is progressively less efficient as the numbers of rows of data and the complexity of the join queries increase.

A typical way of storing content such as libraries and templates is to place their content into tables in a database. It can be seen that this would develop into a complex database schema, involving 12 or more tables with join tables enabling many to many relationships between primary tables to be recorded. Even if each user is only entitled to one library, the sizes of shared tables and/or the cardinality of individualised library, template and contract and join tables quickly explodes as the numbers of users and numbers of contract content assets grow. The performance of the simplest searches will degrade at a rate greater than or equal to O(log(n))—generally the most efficient search available in an indexed database (O(log(n) is the computational complexity of a simple look up in a btree index, where the number of rows in the table is n and the base of the logarithm is the bucket size used by the index).

More complex searches involving joins of tables (say, find all of the variables used in each of the clauses in all of the library) will degrade in performance much faster than O(log(n)) in a relational database data schema. In MySQL, for instance, data from the clause table would need to be combined with data from the variables table perhaps using foreign keys held in a common join table and the resulting super-table would then need to be searched to produce the result required—all of the variables used by each of the clauses. This result would need to be derived every time it was required, unless cached, with the attendant cache invalidation issues.

The size of the table would be an important factor: the bigger the super-table, the more the memory required to search it. This would lead to the need to use bigger, more costly servers with more memory and eventually there would be no choice other than to shard tables across different machines, whereupon joins would become very complex.

As the user requirements of an application evolve, inevitably changes to the application's databases are required. These changes are complex and risky to implement because they may well involve changing the schema of an already sharded, horizontally scaled database. The technical cost of making improvements that users require is likely to slow the pace of change that the application can accommodate.

Preferred embodiments use an approach that does not suffer from these issues. Rather than coming down on one side or the other of the relational/NoSQL debate, embodiments preferably use a hybrid (or polyglot) approach to fulfilling its shared file system, data storage and agility requirements, and solving the difficulties described above.

Hybrid Relational/NoSQL technologies such as PostgreSQL or NoSQL database technologies may be used such as Redis, MongoDB, Apache Cassandra or graph databases such as Janusgraph coupled with NoSQL databases such as Apache Cassandra and search engines such as Elasticsearch.

NoSQL databases often are designed to scale easily and provide more flexibility in the schemas of data that they accept. Apache Cassandra, for instance, natively scales and replicates data over many server instances in a self-managing token ring network. Arbitrary ‘columns’ of data can be stored in the ‘rows’ of a Cassandra database. Indexing is possible but joins are not and instead developers denormalise data by reproducing it in the contexts in which searches require it. This means that consistency can become an issue.

The main prongs of that strategy are as follows:
Reduced reliance on complex relational database operations. Limited or no SQL database storage is used. In some embodiments, MySQL may be used for persisting records of libraries, templates, documents and metadata. That use is consistent with use of a NoSQL database with indexed fields, avoiding complex relational database joins.
Leveraging an easily scalable shared file system.
Leveraging JSON/XML duality and the DocxEngine microservice, as described further below

Enforcing JSON/XML duality in libraries, templates and documents helps scaling and application feature flexibility in a number of ways:
a. The JSON objects that are commonly required by the system can be derived once from the XML document and stored for later use in a scalable database. The DocxEngine microservice parses and indexes the library to extract information such as the occurrence of variables by clause. So long as the library is not modified, this data can be reused by the system. Once the library changes, the JSON is regenerated and returned to the database. Its recovery requires a single O(log(n)) index lookup and because no particular select or join is required to recover it, the information can be stored in an easily scalable NoSQL database. There is a huge performance benefit each time the metadata is required and only one record to invalidate when the metadata becomes stale. Templates and contract documents are handled similarly.
b. Rather than using multiple tables in a database, each library is preferably represented by a single row record in a database, a piece of rich metadata and a file path in a file system. The relevant search/query results required by the system are all calculated by a DocxEngine microservice as and when the library is altered and they are set out in the metadata that just needs to be retrieved. If a bespoke search is required within a JSON object this can for example be delegated to a MongoDB search or a GraphQL query. The file can be retrieved at will from the virtual file system, which scales. As a result of this approach, allowing users to own any number of libraries templates and contracts becomes feasible.
c. As the system and libraries evolve, changing or extending the information schemas represented/contained in a library or template becomes a matter of altering the DocxEngine implementation/endpoints and updating the JSON schema of the metadata, rather than redesigning, testing and deploying new database schemas. This makes the system much easier to adapt and extend. Unit tests define the functionality of the DocxEngine, which reduces the risk of making alterations to it or the information schemas involved.
d. Recording templates and libraries and documents as discrete units of information (a row record, with metadata and file path for each version, say) allows them to be represented as nodes in a graph database. Arbitrary numbers of nodes can be used to represent each user's graph of libraries, templates and documents, and arbitrary relationships between each node can be used to give each library and template context and provide other information. Graph databases like this are very flexible and largely schema free. Adding new nodes and relationships (say negotiation chats attached to a contract) becomes feasible without multiplying the number of joins required to make queries. Modern graph traversal engines such as the Apache Tinkerpop project's Gremlin Graph Traversal Machine and Language make it possible to recover hundreds of pieces of information related to a contract (versions, negotiation chat comments, library metadata, template metadata, user permissions, reminder events, key words etc . . . ) in a time period consistent with a good user experience.

The Docxengine microservice parsing tasks (main endpoints) may include: /template/nakeinstructions
Returns instructions for a contract questionnaire and contract rendering as a json object
Parses and indexes template docx, library docx and uses library meta data;
builds skeleton json object setting out all clause options in the template, collects variables required and collates metadata for clauses and variable choices in the user interface;
Handles any template overrides using metadata from the template footnotes;
Identifies all possible definitions a contract might use, collates metadata;
Generates ‘hymnsheet’ which guides the order in which the clauses are to appear in the agreement;

/contract/render
Generates contract docx from instructions;
Parses and indexes template docx, library docx and uses instructions and library meta data;
Renders the contract clauses, variables and definition table on the basis of the options and answers specified in the instructions
Handles autonumbering and tidies document (removing footnotes etc).

/library/makestagingmeta
Returns updated library meta data.
Parses existing library meta, existing staging meta and newly staged meta.
Adds/updates/deletes staging meta information (produced on update of a clause, variable or definition) within the library meta data.

/library/handlecommitobject
Returns a new library docx
Parses and indexes existing library file, uses existing library meta and the commit object.
Takes committed staging meta information and regenerates the library on the basis of the changes made;
Adds, updates or deletes clauses, variables and definitions in the main body, rewrites footnotes with the right metadata.

/library/makemetainfo
Returns a fresh set of library meta data;
Parses and indexes a library docx and uses existing meta information.
Parsing process analyses clauses, variables and definitions in the main body of the docx and footnotes for metadata.
Captures variable and definition usage information on a per clause basis.

/library/makeabinitio
Returns an empty library docx with initial content and footnotes;

/library/makeclone
Returns a library docx that is the clone of the library described by a commit object.
Parses and indexes existing library file to be cloned, uses existing library meta and the commit object describing that library.
Starts by creating an empty library docx with initial content and footnotes.
Takes committed staging meta information and regenerates the library on the basis of the changes made.
Parses commit object and library docx, uses existing library meta.
Adds, updates or deletes clauses, variables and definitions in the main body, rewrites footnotes with the right metadata.
This endpoint would be adapted to run layered builds of libraries where the commit object was sourced from a content hub online.

/template/makemetainfo
Returns a fresh set of template meta data;
Parses and indexes a template docx and uses the library meta information for the library that a template depends on.
Generates template logic object setting out cause directives and their underlying clauses and logic operators.
Captures metadata in footnotes that overrides library clause, variable and definition metadata for the purpose of the template
Captures clause, variable and definition usage information for the template.

/template/handlecommitobject
Returns a new template docx
Parses the template commit object including clause directives and override meta data.
Takes committed staging meta information and generates a template from scratch;

### BRIEF DESCRIPTION OF THE DRAWINGS

Embodiments of the present invention will now be described by way of example only with reference to the accompanying drawings in which:

FIG. 1 is a schematic diagram of a system according to an embodiment of the present invention;

FIG. 2 is a schematic diagram illustrating aspects of the system of FIG. 1 in greater detail;

FIG. 3 is a schematic diagram illustrating example aspects of a document element; and,

FIG. 4 is an illustration of a system according to a further embodiment of the present invention.

### DETAILED DESCRIPTION

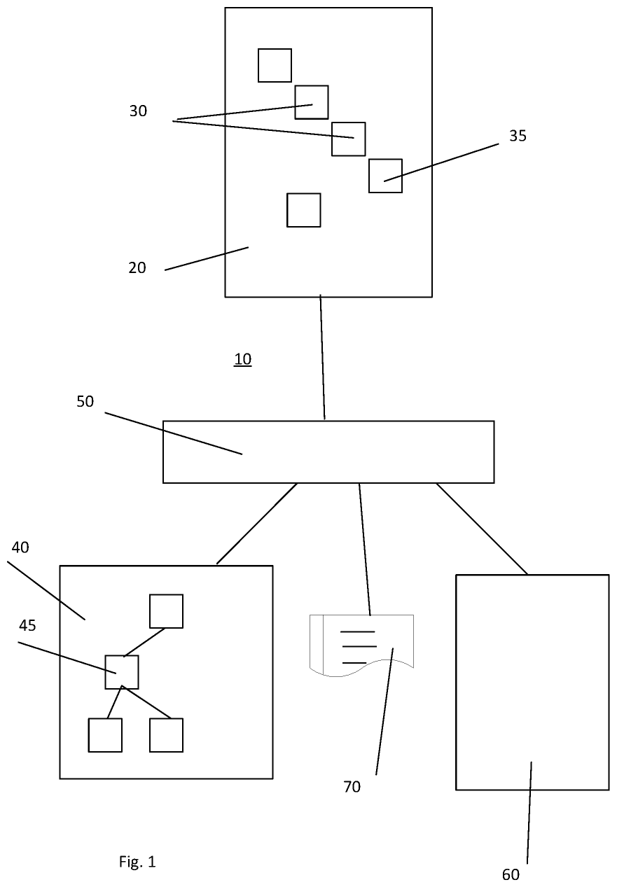

FIG. 1 is a schematic diagram of a system for facilitating complex document drafting and management according to an embodiment of the present invention.

The system 10 includes a data repository 20 storing a plurality of document elements 30. Each document element includes at least a part of a clause for use in a complex document and each individual clause includes provisions and terms relating to conditions affecting one or more parties. One or more of the document elements 30 is a variable document element 35 which includes variables to be substituted with content when an instance of the document element 35 is used to create a complex document. One or more of the document elements 30 may be a definition document element to be included when an instance of the document element 35 containing the definition is used to create a complex document.

The system also includes a database 40 encoding data objects 45, each data object 45 relating to a document element 30 in the data repository 20. The data objects 45 in the database 40 define between them a framework. In particular, the framework comprises a hierarchy of the data objects 45. Document elements 30 of subordinate data objects 45 in the hierarchy override or populate document elements 30 of superior data objects in the hierarchy.

The system further includes a processor 50 configured to execute computer program code to parse the framework and retrieve the data objects of the framework from the database 40 to identify any conditional clause options applicable and the variables in variable document elements used.

The system further includes a user interface 60 configured to generate a human readable questionnaire on the clause options and variables, to obtain user inputs on both and store the user inputs in the database 40.

The processor 50 is configured to execute computer program code to compile the complex document 70 by retrieving the document elements 30/35 from the data repository, applying clause option choices, identifying definitions to include and populating the variables of variable document elements using the user inputs and combining the document elements 30/35 according to the framework.

Within the system 10, the complex document exists as the collection of selected document elements and their organisation designated by the framework. As such, complex documents are advantageously defined and stored in a distributed representation that uses their respective framework and document elements.

Changes and updates are easy to implement whilst maintaining consistency across the entire complex document. Advantageously, the document elements 30/35 are maintained independently of the complex documents 70. The document elements 30/35 are independently updatable and usable across multiple complex documents.

Preferred embodiments of the system are described below and provide a graphical user interface through which the document elements and framework can be manipulated. Additionally, due to the manner in which document elements are defined and maintained, they can not only be updated independently to the complex documents but they can also be traded, shared or otherwise imported or exported between systems, companies etc whilst maintaining internal integrity of the complex documents. In preferred embodiments, a compiled complex document can be displayed on-screen, saved as a text document (such as a formatted word-processing format document) and/or shared with other parties. The system 10 may also include functionality allowing document elements and/or complex documents to be negotiated or collectively edited and commented upon such that multiple parties can work on the document elements and framework.

Embodiments of the present invention are particularly suited to drafting, maintenance, negotiation and storage of complex documents in the form of legal documents such as contracts but also find application in other types of complex documents as noted above.

The document elements in the data repository may be files. In a preferred embodiment described below, each document element includes a JSON object. This is preferably stored in a database and may be stored in the framework database 40. Preferably, document elements also include a content file such as an MS Word (®) format file.

Document elements need not be for individual clauses or provisions they could he parts of clauses or provisions or they could, preferably, be collections of clauses or provisions in the form of libraries.

The database 40 may be a relational or other form of database, including a graph database. It may also be a flat file data store in which data objects relating to document elements are listed.

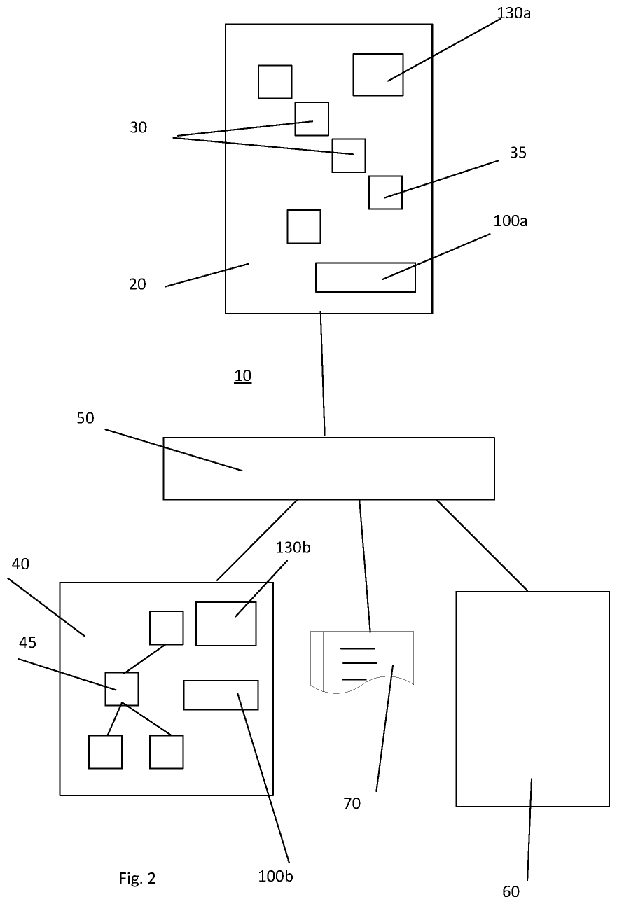

FIG. 2 is a schematic diagram illustrating aspects of the system of FIG. 1 in greater detail.

In the embodiment of FIG. 2, the document elements 30/35 are in the form of libraries. As discussed above, while a library may only have one clause or clause part, typically, and preferably, a plurality of clauses or clause parts (such as definitions) are included in each library. Preferably, each document element has a machine readable form (preferably a JSON encoded object) and a corresponding word-processable file (such as an MS Word (®) document). Content in each form is replicated. Document elements exist in this dual form and should one of the two forms be updated, the system is configured to update the other to reflect it. In this way, the document elements can be edited in a word processor, or as code either manually or visually through a graphical user interface.

Preferably, a header template 100 is used to direct which libraries, or clauses from libraries are used in a complex document. The header template may be, be part of, or may be linked to, the data objects.

Finally, this embodiment includes a graphical user interface 60 which is arranged to receive inputs, preferably drag and drop type inputs, from a user to manipulate the complex document being defined or modified.

In use, a user accesses the graphical user interface 60 and is presented, from the data repository 20, with representations of available libraries (document elements 30/35). Where a library includes multiple clauses, the user is presented, via the graphical user interface 60 with a representation of the clauses enabling a subset to be selected. When multiple libraries are selected, the user interface enables the user to organise the libraries into a hierarchy and define subordinate and superior relationships between the document elements 30/35. This is captured by the user interface 60 and encoded within the header template 100. The header template 100 may also be populated with metadata and also guidance on how the human readable questionnaire is to be presented (for example a particularised user message). Additionally, the template may also include layout definitions, identifying positioning within the generated complex document that particular clause or clause types may occupy—for example a definitions section, a section identifying parties, a section on clauses relating to termination etc. The header template preferably has an instance of the document repository 20 as a word processable document (100a) and also in the database 40 as a JSON or other machine readable form 100b.

The header template 100 can be predetermined and include conditional layout/headers—for example, there may be a section on execution (i.e.

how the complex document is to be executed) that is only included if there are clauses on execution. On the other hand, there may be sections that are always included irrespective of the other clauses in the header template.

Having selected and organised the libraries, the user can then, via an appropriate control or control(s), save the constructed complex document to the database 40. Preferably, the data saved to the database is in the form of a commit action that saves to the database the recent changes and which, when combined with the header template 100 and libraries and historic commit actions reconstructs the current state of the complex document. Preferably changes to libraries and header templates are also saved in the form of commit actions in the same way, allowing libraries and templates to be reconstructed from historic commit actions.

On saving the complex document, a questionnaire script 130 is also created. The questionnaire script 130 preferably has an instance of the data repository 20 as a word processable document (130a) and also in the database 40 as a JSON or other machine readable form 130b.

The questionnaire script 130 takes any instructions from the template along with variables from the document elements and is placed on a form that when executed presents a user interface that prompts a user to select between alternative clause options (where applicable) and provide values for the variables to populate and captures those values. Preferably, the values are encoded within the questionnaire script 130.

The questionnaire script 130 is preferably accessed, executed and completed with answers via the user interface 60 or some other website or mobile application. However, it will be appreciated that the answers could be obtained in many ways and in one embodiment the questionnaire script 130 could be sent as a word processable or other file type that executed independently to the system 10 and obtains responses that are then sent back to the system.

The instructions for the complex document allow a screen view version of the document to be compiled in a viewing format such as html. The screen view of the complex document is preferably recompiled to reflect user inputs to the questionnaire. The instructions capture the user inputs as work progresses prior to being persisted to the database 40. The answers are preferably stored within the questionnaire script such that it can be resumed/replayed from its last state. However, it will be appreciated that the answers could be stored separately and/or remotely.

Additionally the user interface 60 further includes a control via which the user can trigger compilation of the complex document for distribution as a complete document, say for execution. In compiling the complex document 70, the system 10 retrieves the respective files for the used document elements 30 from the data repository 20 and combines them in dependence on the framework, the template 100, the clause option and variable values in the questionnaire script 130 and also instructions in the document elements themselves (and in particular in the machine readable version of the file). If a complex document has been individually negotiated, clause content may also be sourced from the instructions.

Once compiled, the complex document can be presented on screen or saved in a form ready for electronic sharing, printing and/or execution (whether manually or by electronic signature). Preferably, the fact that the complex document has been saved for execution is recorded in the database 50 or elsewhere such that further updates are not applied (or the user is prompted before doing so) such that the execution version state is frozen. The complex document could be used as a template and a version could be allowed to be updated but the executed version is preferably protected.

As actions on document elements are preferably recorded as a sequence or recipe of commit actions, they can be used to recreate an equivalent framework that can be used, edited or extended as desired. This means that as long as the base document elements are held or accessible at a shared repository, co-working, commenting or negotiation on complex documents can be achieved through exchange of commit actions.

Additionally, in the case of yet-to-be executed complex documents, the updates can be pushed to or pulled by anyone holding the complex document and its framework modified so that it reflects frameworks held elsewhere. In this manner, remote control of frameworks can be provided to organisations having distributed systems or facilities. Additionally, frameworks can be maintained as a service—they can be licensed or otherwise purchased or shared and as and when the originator (or someone else) updates it, these updates can be shared as the recorded commit actions. Not only does this reduce communication overhead, it also minimises what is being communicated so that sensitive information does not need to leave the respective repositories. Collaborative creation and distribution of document elements is also enabled by this system.

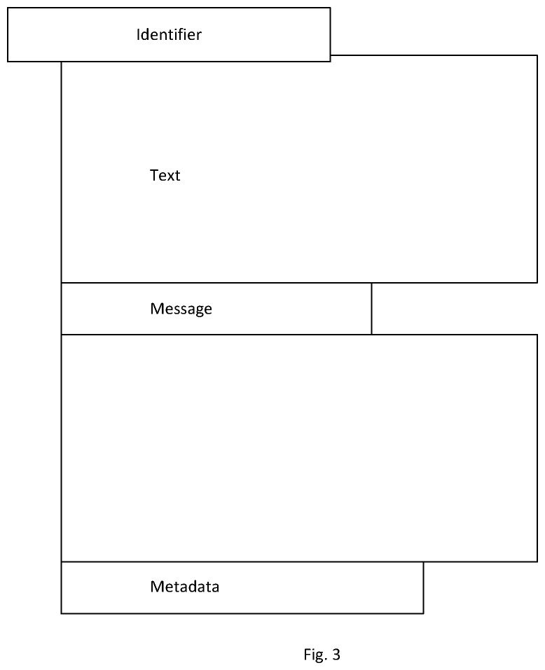

FIG. 3 is a schematic diagram illustrating example aspects of a document element.

It will be appreciated that document elements may vary in complexity and form, depending on the intended complex document type and also their likely role in that document.

In one embodiment, document elements include fields as shown in FIG. 3 that include:

Identifier—for use in referencing the document element. Preferably this is globally unique and may optionally include version information so as to enable different versions of a document element to be identified;

Text—content of the document element to be used in the complex document—in the case of variable or option-based elements, the variables or options may be specified here or in a separate filed;

Message—the description of the document element to be displayed in the questionnaire or in the user interface to describe the element and/or set out what the user needs to do to answer the variable;

Formatted text—preferably a document element includes both formatted and non-formatted text. Formatted text can be added directly into a complex document or used in its display, whereas non-formatted text is better for searching and analysis.

Metadata may also be included, for example importance of the document element, relevance to other document elements . . .

Preferably, this information is used to assemble the questionnaire script 130. The script is preferably self-contained and adaptive such that if a user selects a particular option for a content element, any content elements needed (such as definitions, more detailed clauses etc) are automatically added to the questions included within the questionnaire and the order in which questions are posed may be altered to obtain answers that subsequent questions require in good time. Preferably the script 130 is executable in a web browser.

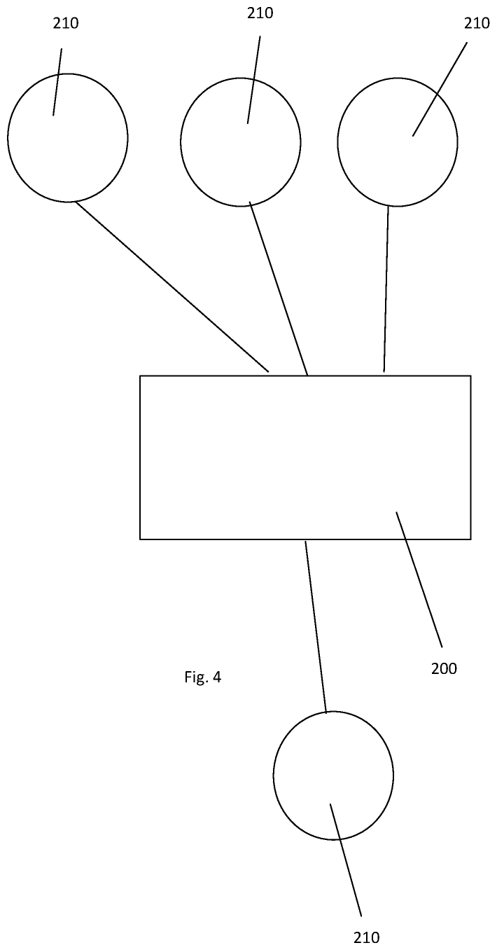

FIG. 4 is an illustration of a system according to a further embodiment of the present invention.

In this embodiment, a central marketplace or content distribution server 200 acts as an intermediary between multiple client systems 210. Each client system runs an instance of the system 10 described above but is arranged to be able, on demand or in some cases automatically, to receive updates to document elements, templates or other objects from the central marketplace server 200.

For example, document elements may be updated as part of a service to reflect changes in legislation or caselaw. They may also be modified to reflect recommended best practice. The server 200 may also enables parties to buy, sell or trade libraries, clause definitions and complex document templates. As highlighted above, it may be that the document elements themselves are communicated between the server 200 and systems 210 but it is equally possible that commit actions detailing how to change existing document elements are communicated.

In the latter case, a sequence of commit actions can be scripted, allowing frameworks to be rebuilt in layers, where changes may appear in any layer arbitrarily.

Any modified library or template is validated against its dependent data objects (templates or contracts) to ensure that the modified library or template is compatible with the existing frameworks that they form part of. It is to be appreciated that certain embodiments of the invention as discussed above may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set so forth.

Although illustrated embodiments of the present invention have been described, it should be understood that various changes, substitutions, and alterations can be made by one of ordinary skill in the art without departing is from the present invention which is defined by the recitations in the claims below and equivalents thereof.

1. A system for facilitating complex document drafting and management, comprising:
a data repository storing a plurality of document elements, each document element including at least a part of a clause for use in a complex document and each individual clause including provisions and terms relating to conditions affecting one or more parties, one or more of the document elements comprising a variable document element which includes variables to be substituted with content when an instance of the document element is used to create a complex document;
a database encoding data objects, each data object relating to a document element in the data repository, the database defining a framework, the framework comprising a hierarchy of the data objects whereby document elements of subordinate data objects in the hierarchy override or populate document elements of superior data objects in the hierarchy;
a processor configured to execute computer program code to parse the framework and retrieve the logical collection and hierarchy of data objects of the framework from the data repository to identify the variables in the document elements;
a user interface configured to generate a human readable questionnaire on the variables, to obtain user inputs on the variables and store the user inputs in the database; and
the processor being further configured to execute computer program code to compile the complex document by retrieving the document elements from the data repository, populating the variables with the user inputs and combining the document elements according to the hierarchy, wherein the document elements are maintained independently of the complex documents, the document elements being independently updatable and usable across multiple complex documents.

2. The system of claim 1, the data repository further storing a collection element, the collection element linking to a plurality of the document elements and the collection element being usable in place of a document element in the framework, the processor being further configured to execute computer program code to compile the complex document from a framework by retrieving the document elements corresponding to each collection element in the framework, populating the variables with the user inputs and combining the document elements according to the hierarchy, wherein the collection elements are maintained independently of the complex documents, the collection elements being independently updatable and usable across multiple complex documents.

3. The system of claim 2, further comprising a plurality of collection elements wherein at least two of the collection elements link to a same one of the document elements, whereby the provisions and terms from the document element are used in the at least two collection elements and an update to the document element causes an update to all instances of the document element in a complex document when the complex document is compiled.

4. The system of claim 2, wherein the collection element in the data repository includes a logical operator.

5. The system of claim 1, the database further comprising a record for each compiled complex document, its framework and document element and collection elements used.

6. The system of claim 1, further comprising a graphical user interface configured to display a graphical representation of the framework, the graphical user interface being configured to receive user inputs on drag and drop operations to manipulate the framework and is responsive to update the framework in the database in accordance with the user inputs,

7. The system of claim 6, further comprising a graphical user interface configured to display a graphical representation of the document elements and collection elements in the data repository, the graphical user interface being configured to receive user inputs on drag and drop operations to add, remove or move document elements or collection elements in the framework and is responsive to update the framework in the database in accordance with the user inputs.

8. The system of claim 1, wherein upon the change corresponding to a document element, the system being configured to create a copy of the document element, update the hierarchy to refer to the copy and apply the change to the copy.

9. The system of claim 8, wherein the graphical user interface is configured to receive user inputs on positioning of a clause in the complex document, the processor being configured to execute computer program code to identify, from the changes to the complex document, one or more changes to the hierarchy to reflect changes to positioning of the clause and to update the hierarchy in dependence on the changes.

10. The system of claim 1, wherein each document element comprises a json object.

11. The system of claim 10, wherein the processor is configured to execute each json object according to the hierarchy when compiling the complex document.
